(19) United States
(12) Patent Application Publication
(10) Pub. No.: US 2021/0289266 A1
(43) Pub. Date: Sep. 16, 2021

(54) VIDEO PLAYING METHOD AND APPARATUS

(71) Applicant: HUAWEI TECHNOLOGIES CO.,LTD., Shenzhen (CN)

(72) Inventors: Wenjie Zhang, Nanjing (CN); Mang Wang, Shenzhen (CN)

(73) Assignee: HUAWEI TECHNOLOGIES CO.,LTD., Shenzhen (CN)

(21) Appl. No.: 17/333,015

(22) Filed: May 28, 2021

Related U.S. Application Data
(63) Continuation of application No. PCT/CN2019/115889, filed on Nov. 6, 2019.

(30) Foreign Application Priority Data
Nov. 28, 2018 (CN) 201811434790.9

(51) Int. Cl. H04N 21/472; H04N 21/488; G06K 9/00; G06N 3/02

(52) U.S. Cl. CPC H04N 21/47217; G06N 3/02; G06K 9/00718; H04N 21/4882

(57) ABSTRACT

A video playing method and apparatus are provided. In the method, a terminal device sends, to a server, a first request, the first request requesting a video address of a video to be played by the terminal device, and receives a first response sent by the server, the first response includes the video address and dotting information of the video, the dotting information includes a dotting position of the video and a video clip storage address of a video clip corresponding to the dotting position. The terminal device obtains the video based on the video address, and loads the corresponding video clip based on the video clip storage address of the video clip corresponding to the dotting position. The terminal device plays the video clip.

### CROSS-REFERENCE TO RELATED APPLICATIONS

This application is a continuation of International Application No. PCT/CN2019/115889, filed on Nov. 6, 2019, which claims priority to Chinese Patent Application No. 201811434790.9 filed on Nov. 28, 2018. The disclosures of the aforementioned applications are hereby incorporated by reference in their entireties.

### TECHNICAL FIELD

This application relates to the field of communications technologies, and in particular, to a video playing method and an apparatus.

### BACKGROUND

With rapid development of multimedia technologies and network technologies, digital video use grows rapidly. Competition between video platforms is increasingly fierce. To improve user experience and attract more users' attention on video content, a video platform usually performs marking in positions of highlights in a video. For example, dotting is performed on a progress bar of the video to form a plurality of dotting positions. When a user touches or taps a dotting position, text information of video content in the dotting position is displayed in the dotting position. This helps the user to switch, in a relatively short time, to a position of a section that the user wants to watch, and also ensures that the user can quickly find a relatively highlighting section in the video.

However, in order not to affect normal video viewing, the displayed text information usually comprises relatively brief sentences, as limited by a video interface. For some movies and TV series with intricate plots, the brief text information can only express limited content, and consequently the user cannot understand video content well. If the text information does not clearly summarize the video content, the user experience is affected.

### SUMMARY

A video playing method comprises receiving, by a server, a first request from a terminal device, the first request requesting a video address of a video to be played by the terminal device; and sending, by the server, a first response to the terminal device, the first response comprising the video address and dotting information of the video, the dotting information comprising a dotting position of the video and a storage address of a video clip corresponding to the dotting position.

In some embodiments, after the sending, by the server, the first response to the terminal device, the method further comprises receiving, by the server, a second request sent by the terminal device, the second request requesting the video clip corresponding to the dotting position, the second request comprising the storage address of the video clip; obtaining, by the server based on the storage address of the video clip, the video clip; and sending, by the server, a second response to the terminal device, the second response comprising the video clip corresponding to the dotting position.

In some embodiments, before the sending, by the server, the first response to the terminal device, the method further comprises segmenting, by the server, the video into a plurality of video clips; determining, by the server, a degree of highlighting of each video clip of the plurality of video clips based on a preset neural network model; selecting, by the server, N video clips of the plurality of video clips based on the degree of highlighting of each video clip of the plurality of video clips; and determining, by the server, N dotting positions of the video based on positions of the N video clips in the video, wherein each dotting position of the N dotting positions corresponds to a video clip of the N video clips.

In some embodiments, the determining, by the server, the degree of highlighting of the each video clip based on a preset neural network model comprises extracting, by the server, a first feature of the each video clip based on the preset neural network model, the first feature comprising one or both of a temporal feature of a frame sequence or a spatial feature of the frame sequence; and determining, by the server, the degree of highlighting of the each video clip based on the first feature of the each video clip.

In some embodiments, the segmenting, by the server, the video into the plurality of video clips comprises performing, by the server, shot segmentation on the video to obtain a plurality of groups of image frames, wherein each group of image frames of the plurality of groups of image frames comprises a plurality of consecutive image frames; and synthesizing, by the server, the plurality of groups of image frames into one or more video clips with a preset length.

In some embodiments, the segmenting, by the server, the video into the plurality of video clips comprises performing, by the server, shot segmentation on the video based on shot types of the video to obtain a plurality of groups of image frames, wherein each group of image frames comprises a plurality of consecutive image frames; and synthesizing, by the server, the plurality of groups of image frames into one or more video clips, wherein a similarity between two adjacent frames in a video clip falls within a preset range.

A video playing method comprises receiving, by a terminal device, a first response sent by a server after sending a first request to the server, the first request requesting a video address of a video to be played by the terminal device, the first response comprising the video address and dotting information of the video, the dotting information comprising a dotting position of the video and a storage address of a video clip corresponding to the dotting position; obtaining, by the terminal device, the video based on the video address; loading the corresponding video clip based on the storage address of the video clip; and playing, by the terminal device, the video clip.

In some embodiments, the loading, by the terminal device, the corresponding video clip comprises sending, by the terminal device, a second request to the server, the second request requesting the video clip, the second request comprising the storage address of the video clip; and receiving, by the terminal device, a second response sent by the server, the second response comprising the video clip corresponding to the dotting position.

In some embodiments, the method further comprises displaying, by the terminal device, a video clip corresponding to at least one dotting position closest to a current playing position when playing the video.

In some embodiments, the method further comprises playing, by the terminal device after receiving a trigger operation in the dotting position, the video clip corresponding to the dotting position when playing the video.

A server comprises a processor; and a memory coupled to the processor and configured to store instructions that, when executed by the processor, cause the server to be configured to receive a first request from a terminal device, the first request requesting a video address of a video to be played by the terminal device; and send a first response to the terminal device, the first response comprising the video address and dotting information of the video, the dotting information comprising a dotting position of the video and a storage address of a video clip corresponding to the dotting position.

In some embodiments, the server is further configured to receive a second request sent by the terminal device, the second request requesting the video clip corresponding to the dotting position, the second request comprising the storage address of the video clip corresponding to the dotting position; obtain, based on the storage address of the video clip, the video clip; and send a second response to the terminal device, the second response comprising the video clip corresponding to the dotting position.

In some embodiments, before the first response is sent to the terminal, the server is further configured to segment the video into a plurality of video clips; determine a degree of highlighting of each video clip of the plurality of video clips based on a preset neural network model; select N video clips of the plurality of video clips based on the degree of highlighting of the each video clip of the plurality of video clips; and determine N dotting positions of the video based on positions of the N video clips in the video, wherein each dotting position corresponds to a video clip of the N video clips.

In some embodiments, the server is further configured to extract a first feature of the each video clip based on the preset neural network model, the first feature comprising one or both of a temporal feature of a frame sequence or a spatial feature of the frame sequence; and determine the degree of highlighting of the each video clip based on the first feature of the each video clip.

In some embodiments, the server is further configured to perform shot segmentation on the video based on shot types of the video to obtain a plurality of groups of image frames, wherein each group of image frames of the plurality of groups of image frames comprises a plurality of consecutive image frames; and synthesize the plurality of groups of image frames into one or more video clips with a preset length.

In some embodiments, when segmenting the video into the plurality of video clips, the server is further configured to perform shot segmentation on the video based on shot types of the video to obtain a plurality of groups of image frames, wherein each group of image frames of the plurality of groups of image frames comprises a plurality of consecutive image frames; and synthesize the plurality of groups of image frames into one or more video clips, wherein a similarity between two adjacent frames in a video clip falls within a preset range.

A terminal device comprises a processor; and a memory coupled to the processor and configured to store instructions that, when executed by the processor, cause the terminal device to be configured to send a first request to a server, the first request requesting a video address of a video to be played by the terminal device; receive a first response sent by the server, the first response comprising the video address and dotting information of the video, the dotting information comprising a dotting position of the video and a video clip storage address of a video clip corresponding to the dotting position; obtain the video based on the video address; load the corresponding video clip based on the video clip storage address of the video clip corresponding to the dotting position; and play the video clip.

In some embodiments, the terminal device is further configured to send a second request to the server, the second request requesting the video clip corresponding to the dotting position, the second request comprising the video clip storage address of the video clip; receive a second response sent by the server, the second response comprising the video clip corresponding to the dotting position; and load the video clip based on the second response.

In some embodiments, the server is further configured to display a video clip corresponding to at least one dotting position closest to a current playing position when playing the video.

In some embodiments, the server is further configured to play, after a trigger operation in the dotting position is received, the video clip corresponding to the dotting position when playing the video.

### BRIEF DESCRIPTION OF DRAWINGS

FIG. 1 is a diagram of displaying text information in a dotting position in the prior art;

FIG. 2 is a diagram of an architecture of a network system according to an embodiment of the application;

FIG. 3 is a diagram of a video playing method according to an embodiment;

FIG. 4A and FIG. 4B are a structural diagram of a neural network model according to an embodiment;

FIG. 5 is a diagram of a video clip generation method according to an embodiment;

FIG. 6 is a diagram of another video clip generation method according to an embodiment;

FIG. 7 is a structural diagram of a server according to an embodiment;

FIG. 8 is a structural diagram of a terminal device according to an embodiment;

FIG. 9 is a structural diagram of a server according to an embodiment;

FIG. 10 is a structural diagram of a server according to an embodiment;

FIG. 11 is a structural diagram of a terminal device according to an embodiment; and

FIG. 12 is a structural diagram of a server according to an embodiment.

### DESCRIPTION OF EMBODIMENTS

This application provides a video playing method and an apparatus, to resolve a prior-art problem that user experience is affected because displayed text information cannot summarize video content well.

To make the objectives, technical solutions, and advantages of this application clearer, the following further describes this application in detail with reference to the accompanying drawings. A specific operation method in method embodiments may also be applied to an apparatus embodiment or a system embodiment.

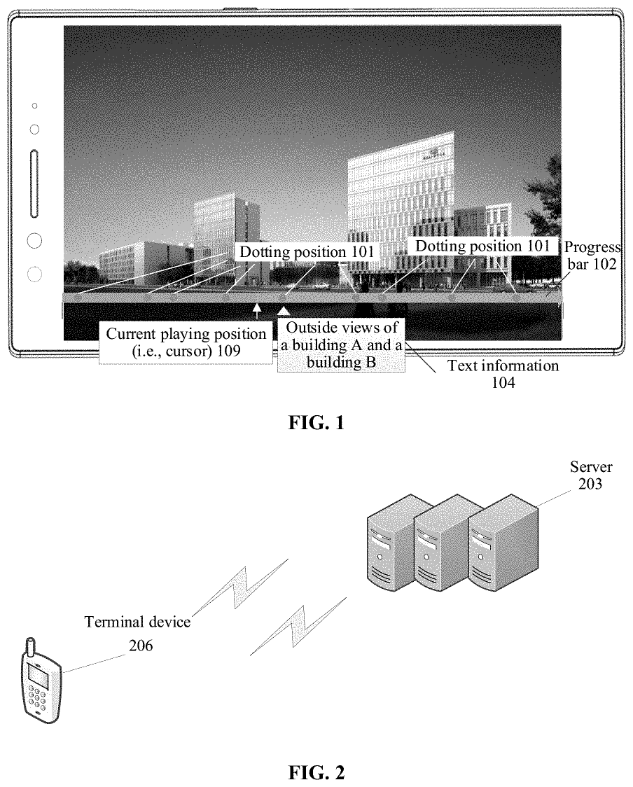

FIG. 1 is a diagram of displaying text information in a dotting position in the prior art. Video dotting is a process of describing a key frame and summarizing video content in a video. As shown in FIG. 1, in an existing video dotting solution, a terminal device usually sets one or more dotting positions 101 on a progress bar 102 of a video, and marks text information 104 of video content in a dotting position 101. A user may move a cursor 109 to the dotting position 101 by moving a mouse. In this case, text information 104 of the video content is displayed in the dotting position 101. However, the text information 104 of the video content is usually relatively concise, and cannot intuitively reflect a degree of highlighting of the video content. Consequently, the user may miss some relatively highlighting images, and user experience cannot be effectively improved.

FIG. 2 is a diagram of an architecture of a network system according to an embodiment of the application. The network architecture includes a terminal device 206 and a server 203.

The server 203 is a remote server deployed in a cloud, or may be a server 203 that is deployed in a network and that can provide a service. The server 203 has a video processing function and a data computation function. For example, the server 203 may perform video segmentation, and determine a degree of highlighting of a video clip. The server 203 may be an ultra-multi-core server 203, a computer on which a graphics processing unit (graphics processing unit, GPU) cluster is deployed, a large distributed computer, a cluster computer with pooled hardware resources, or the like. In this embodiment of this application, the server 203 may generate dotting information, and send a video address and the dotting information to the terminal device 206 after the terminal device 206 requests the video address from the server 203.

The server 203 may further segment a video, and then determine degrees of highlighting of one or more video clips obtained after the segmentation. The server 203 may further select a plurality of relatively highlighting video clips from the video clips obtained after the segmentation, and perform video synthesis on the relatively highlighting video clips, or store the relatively highlighting video clips.

The server 203 may store video data required by the terminal device, including source data of the video, the video clips obtained after the segmentation, the degree of highlighting of each video clip, a video obtained after the video synthesis (corresponding to a first video in the embodiments of this application), and an animated image.

The terminal device 206 may initiate a request (corresponding to a first request and a second request in the embodiments of this application) to the server 203, to obtain related data (such as the video address, the dotting information, a storage address of a video clip, the video clip, the video obtained after the video synthesis, and the animated image) from the server 203.

After obtaining the related data, the terminal device 206 performs an operation such as loading or display. For example, after obtaining the video address, the terminal device 206 obtains the video based on the video address. After obtaining the dotting information, the terminal device 206 may load a video clip in a dotting position of the video based on the dotting information. After loading the video clip, the terminal device 206 may further play the video clip. When obtaining the video obtained after the video synthesis or the animated image, the terminal device 206 may display the video obtained after the video synthesis or the animated image to a user.

The terminal device 206 in this application, or referred to as user equipment (user equipment, UE), may be deployed on land, for example, an indoor or outdoor device, a handheld device, or a vehicle-mounted device. Alternatively, the terminal device 206 may be deployed on water (for example, on a ship), or may be deployed in the air (for example, on an airplane, a balloon, or a satellite). The terminal device 206 may be a mobile phone (mobile phone), a tablet computer (pad), a computer with a wireless receiving and sending function, a virtual reality (virtual reality, VR) device, an augmented reality (augmented reality, AR) device, a wireless device in industrial control (industrial control), a wireless device in self-driving (self driving), a wireless device in remote medical (remote medical), a wireless device in smart grid (smart grid), a wireless device in transportation safety (transportation safety), a wireless device in smart city (smart city), a wireless device in smart home (smart home), and the like.

In this embodiment of this application, the server 203 may provide, for the terminal device, an address of a to-be-played video and dotting information of the video. The dotting information includes a dotting position of the video and a storage address of a video clip corresponding to the dotting position. In this way, the terminal device 206 can load the corresponding video clip in the dotting position of the video based on the dotting information, and play the video clip. It is clear that, compared with an existing dotting solution in which only text information is displayed, displaying the video clip in the dotting position of the video can more intuitively reflect video content, and can effectively improve user experience. Based on the network system shown in FIG. 2, an embodiment of this application provides a video playing method.

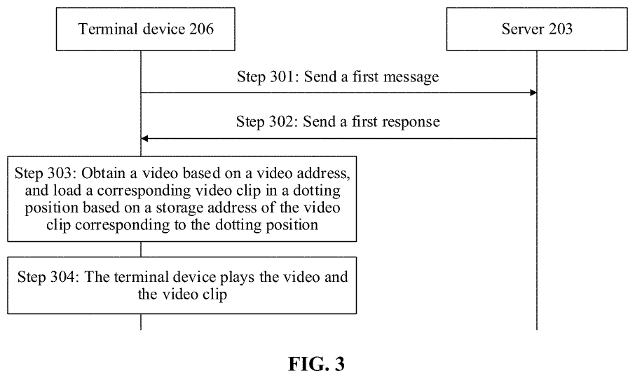

FIG. 3 is a diagram of a video playing method according to an embodiment. As shown in FIG. 3, the method includes the following steps.

Step 301: A terminal device 206 sends a first request to a server 203, where the first request is used to request an address of a video to be played by the terminal device.

When the terminal device 206 determines to play the video, if the video is not locally stored, the terminal device 206 may send the first request to the server 203 to request the address of the video to be played by the terminal device. The address of the video to be played by the terminal device 206 is requested in a plurality of manners. For example, the terminal device 206 may use the first request to carry identification information of the video and an information element indicating to obtain the video address. The foregoing manner is merely an example, and any manner that can be used to request the address of the video to be played by the terminal device 206 is applicable to this embodiment of this application.

Step 302: After receiving the first request from the terminal device, the server 203 sends a first response to the terminal device, where the first response includes the video address and dotting information of the video, and the dotting information includes a dotting position of the video and a storage address of a video clip corresponding to the dotting position.

Step 303: The terminal device 206 obtains the video based on the video address, and loads the corresponding video clip in the dotting position based on the storage address of the video clip corresponding to the dotting position.

Step 304: The terminal device 206 plays the video and the video clip.

After receiving the first request, to send the video address and the dotting information of the video to the terminal device, the server 203 needs to first parse the video to generate the dotting information, that is, needs to determine the dotting position of the video and the video clip corresponding to the dotting position.

In actual application, the server 203 generates the dotting information in many manners, and this is not limited in this application. Any manner in which the generated dotting information includes the dotting position of the video and the storage address of the video clip corresponding to each dotting position is applicable to this embodiment of this application.

The following describes a manner of generating the dotting information provided in this embodiment of this application.

First, the server 203 may segment the video into a plurality of video clips. In this embodiment of this application, a manner of segmenting the video by the server 203 is not limited. The server 203 may segment the video into a plurality of video clips based on a preset length. The server 203 may alternatively segment the video into a plurality of video clips based on displayed content of the video, and the video clips display different content. For example, the server 203 may separate, from the video, clips that display content including a specific scene or character, and synthesize the clips into a video clip. If the video includes a plurality of different scenes or characters, the video may be segmented into a plurality of video clips.

The following lists two manners in which the server 203 segments the video into the video clips:

Manner 1: The video is segmented into a plurality of video clips with a preset length.

In this manner, the server 203 first performs shot segmentation on the video to obtain a plurality of groups of image frames, where each group of image frames includes a plurality of consecutive image frames.

Generally, there are two types of shots in a video: an abrupt shot and a gradual shot. The abrupt shot means that a group of consecutive and associated image frames is directly switched to a next group of consecutive and associated image frames in the video without transition. The gradual shot means that a group of image frames gradually transits to a next group of image frames in the video through chromatic aberration or a spatial effect.

When performing shot segmentation on the video, the server 203 performs video segmentation on the video based on shot types of the video. During the shot segmentation, for an abrupt shot, a point on which a group of image frames is switched to a next group of image frames in the abrupt shot is determined as a segmentation point for segmentation. A previous image frame of the segmentation point is used as an end frame of the group of image frames, and a next image frame of the segmentation point is used as a start frame of the next group of image frames. For a gradual shot, a transition interval in which a group of image frames is switched to a next group of image frames in the gradual shot is determined, a previous image frame of the transition interval is used as an end frame of the group of image frames, and a next image frame of the transition interval is used as a start frame of the next group of image frames. The server 203 may perform shot segmentation on the video based on a difference of histogram features, for example, determine a segmentation point according to a fast shot segmentation (fast shot segmentation, FAST) algorithm to implement shot segmentation, or may perform shot segmentation by using another method, for example, by using a three-dimensional fully convolutional network (3 dimension fully convolutional networks, 3D-FCN).

When performing shot segmentation on the video, the server 203 determines a plurality of segmentation points in the video, to further obtain a plurality of groups of image frames. Each group of image frames includes a plurality of consecutive image frames.

To distinguish between different groups of image frames, the server 203 may obtain a frame number of a start frame (a frame number of a start image frame) and a frame number of an end frame (a frame number of an end image frame) of each group of image frames through shot segmentation, and may further determine a start timestamp and an end timestamp of each group of image frame.

In an optional implementation, after performing shot segmentation, the server 203 may further remove a transition image of each group of image frames. The transition image includes some or all of the following image frames: an all-black image frame or an all-white image frame, an image frame that displays a blurry scene or a blurry character, and a blending frame.

The blending frame is an image frame formed when two different image frames in a video blend. For example, in a video, a previous image gradually disappears or becomes darker, a current image gradually becomes obvious or brighter, and there is an image frame in which the two images overlap. The image frame is a blending frame.

After determining the plurality of groups of image frames, the server 203 may synthesize the plurality of groups of image frames into one or more video clips with the preset length.

For any group of image frames in the plurality of groups of image frames, the plurality of groups of image frames may be classified into three types according to a relationship between the preset length and a time length required for playing each group of image frames (a time span for playing each group of image frames). Type 1: A group of image frames with a time length greater than the preset length. To be specific, the group of image frames includes a relatively large quantity of image frames, the group of image frames may display a plurality of scenes, and the group of image frames forms a long shot. Type 2: A group of image frames with a time length less than the preset length and including a quantity of image frames that is less than a specified value. To be specific, the group of image frames includes a relatively small quantity of image frames, the group of image frames may be insufficient to present a complete scene, and the group of image frames forms a short shot. Type 3: A group of image frames with a time length equal to the preset length or having a relatively small difference from the preset length, which falls within a preset range. In this case, it may be considered that the time length of the group of image frames is approximately equal to the preset length. To be specific, a quantity of image frames included in the group of image frames ranges from the quantity of image frames included in the short shot to the quantity of image frames included in the long shot, the group of image frames may display one or more scenes, and the group of image frames forms a single shot.

In this embodiment of this application, the preset length of the video clip indicates a time length for playing the video clip, and the preset length may be set based on a specific scenario. A setting manner is not limited in this embodiment of this application.

The server 203 may synthesize any group of image frames of one of the different types into one or more video clips with the preset length in a corresponding manner. The following describes a method for synthesizing any group of image frames of one of the different types into a video clip.

1. Any Group of Image Frames of the Type 1:

Any group of image frames of the type 1 includes a relatively large quantity of image frames, and therefore has a relatively long time length. If the time length of the group of image frames is greater than the preset length, the server 203 may segment the group of image frames into one or more video clips with the preset length.

A start frame, an end frame, a start time, and an end time of any video clip fᵢ₊ₘ obtained by segmenting an i^{th} group of image frames may be determined according to the following formula:

$${f}_{i + m} = \{ \begin{matrix}{f}_{( i + m ) \_start \_frame \_number} = {s}_{k\_start \_frame \_number} + m * L * {v}_{fps} \\ {f}_{( i + m ) \_end \_frame \_number} = {s}_{k\_start \_frame \_number} + ( m + 1 ) * L * {v}_{fps} \\ {f}_{( i + m ) \_start \_time} = {s}_{k\_start \_time} + m \times L \\ {f}_{( i + m ) \_end \_time} = {s}_{k\_start \_time} + ( m + 1 ) \times L\end{matrix} \}$$

$$or$$

$${f}_{i + m} = \{ \begin{matrix}{f}_{( i + m ) \_start \_frame \_number} = {s}_{k\_start \_frame \_number} + m * L * {v}_{fps} \\ {f}_{( i + m ) \_end \_frame \_number} = {s}_{k\_end \_frame \_number} + ( m + 1 ) * L * {v}_{fps} \\ {f}_{( i + m ) \_start \_time} = {s}_{k\_start \_time} + m \times L \\ {f}_{( i + m ) \_end \_time} = {s}_{k\_end \_time} + ( m + 1 ) \times L\end{matrix} \}$$

L represents the preset length. When a video clip is obtained through synthesis, a length of the video clip may not be exactly L, and may be greater than or less than L. Therefore, δ is set to represent a length gain, and the length of the video clip ranges from L−δ to L+δ. fᵢ represents an i^{th} video clip, and sₖ represents a k^{th} group of image frames in the video. (s_{(k+n)_end_time}−s_{k_start_time})>L+δ. That is, a length of the group of image frames is greater than the preset length. m=0, 1, 2, . . . , m′−2, m′=INT((s_{k_end_time}−s_{k_start_time})/L), m′ represents a quantity of video clips that can be obtained by segmenting the i^{th} group of image frames, and v_{fps} represents a video frame rate. f_{(i+m)_start_frame_number} represents a frame number of a start frame of the (i+m)^{th} video clip, and s_{k_start_frame_number} represents a frame number of a start frame of the k^{th} group of image frames in the video. f_{(i+m)_end_frame_number} represents a frame number of an end frame of the (i+m)^{th} video clip, and s_{k_end_time} represents an end time of frame numbers of the k^{th} group of image frames in the video.

2. Any Group of Image Frames of the Type 2:

Any group of image frames of the type 2 includes a relatively small quantity of image frames, and therefore has a relatively short time length. If the time length of the group of image frames is less than the preset length, the server 203 may synthesize a plurality of consecutive groups of image frames into one or more video clips with the preset length.

A start frame, an end frame, a start time, and an end time of any video clip fᵢ obtained by synthesizing a plurality of groups of image frames may be determined according to the following formula:

$${f}_{i} = \{ \begin{matrix}{f}_{i \_start \_frame \_number} = {s}_{k\_start \_frame \_number} \\ {f}_{i \_end \_frame \_number} = {s}_{( k + n ) \_end \_frame \_number} \\ {f}_{i \_start \_time} = {s}_{k\_start \_time} \\ {f}_{i \_end \_time} = {s}_{( k + n ) \_end \_time}\end{matrix} \}$$

L−δ≤s_{(k+n)_end_time}−s_{k_start_time}≤L+δ. That is, a total time length of the plurality of consecutive groups of image frames falls within a preset range, and a difference between the total time length and the preset length is relatively small. A time length of any group of image frames in the plurality of consecutive groups of image frames is less than the preset length. sₖ represents a k^{th} group of image frames in the video, and sₖ₊ₙ represents a (k+n)^{th} group of image frames in the video. For descriptions of the parameters in the formula, refer to the foregoing descriptions. Details are not described herein again.

3. Any Group of Image Frames of the Type 3:

Because a quantity of image frames included in any group of image frames of the type 3 ranges from the quantity of image frames included in any group of image frames of the type 2 to the quantity of image frames included in any group of image frames of the type 1, a time length of the group of image frames is less than that of a long shot. If the time length of the group of image frames is equal to the preset length, or if a difference between the time length of the group of image frames and the preset length falls within an error range, and the time length of the group of image frames may be considered to be equal to the preset length, the server 203 may synthesize the group of image frames into a video clip with the preset length.

A start frame, an end frame, a start time, and an end time of any video clip fᵢ obtained by synthesizing a plurality of groups of image frames may be determined according to the following formula:

$${f}_{i} = \{ \begin{matrix}{f}_{i \_start \_frame \_number} = {s}_{k\_start \_frame \_number} \\ {f}_{i \_end \_frame \_number} = {s}_{k\_end \_frame \_number} \\ {f}_{i \_start \_time} = {s}_{k\_start \_time} \\ {f}_{i \_end \_time} = {s}_{k\_end \_time}\end{matrix} \}$$

L−δ≤s_{k_end_time}−s_{k_start_time}≤L+δ. The time length of the group of image frames may be considered to be equal to the preset length. For descriptions of the parameters in the formula, refer to the foregoing descriptions. Details are not described herein again.

Manner 2: The video is segmented into one or more video clips, where a similarity between any two adjacent frames of images in any one of the video clips falls within a preset range. That is, one of the video clips displays one type of scene or similar characters.

In this manner, the server 203 may also perform shot segmentation on the video to obtain a plurality of groups of image frames, where each group of image frames includes a plurality of consecutive image frames. For a shot segmentation manner, refer to related descriptions of the shot segmentation in the manner 1. Details are not described herein again.

Then, for the plurality of groups of image frames obtained after the shot segmentation, image frames that display similar scenes in the groups of image frames may be synthesized into one video clip. If there are different scenes, a corresponding video clip is obtained through synthesis for each of the different scenes, and the server 203 may synthesize the plurality of groups of image frames into a plurality of video clips.

When the video clip is obtained through synthesis, the server 203 needs to determine whether image frames in the plurality of groups of image frames display a similar or same scene. There are many determining manners, and this is not limited in this embodiment of this application. For example, the server 203 may first extract visual features of key frames of shots (for example, a long shot, a short shot, and a single shot), cluster shots with a close time and related semantic content to one scene according to a preset similarity determining criterion, and synthesize the shots into a corresponding video clip. The server 203 may extract the visual features of the key frames of the shots according to the 3D-FCN, or may extract the visual features of the key frames of the shots by using a video frame color histogram method. The server 203 may perform shot clustering by using a tree support vector machine (support vector machine, SVM).

After the server 203 obtains the plurality of video clips through segmentation, the server 203 may directly use a start position of each video clip in the video as a dotting position of the video. In this case, each dotting position corresponds to one video clip. The server 203 may alternatively remove some of the plurality of video clips, and use a start position of each of the remaining video clips as a dotting position of the video. A manner of removing the some video clips by the server 203 is not limited in this embodiment of this application. The some video clips may be randomly removed. Alternatively, a video clip that includes a relatively large quantity of transition shots with a relatively long time may be removed from the plurality of video clips. Alternatively, a video clip may be removed based on an actual application scenario.

A manner of directly determining the dotting position of the video after the plurality of video clips are obtained through segmentation is merely an example for description. Actually, the server 203 may alternatively determine the dotting position of the video more accurately in another manner. The server 203 may first evaluate a degree of highlighting of each video clip, in other words, may first determine the degree of highlighting of each video clip. Then, the server 203 selects a video clip based on the degree of highlighting of each video clip, and then determines the dotting position of the video.

It should be noted that a quantity of dotting positions included in the dotting information is not limited in this embodiment of this application, and there may be one or more dotting positions.

There are many criteria for measuring a degree of highlighting of a video clip. For example, the server 203 may measure a degree of highlighting of a video clip based on a quantity of times that the video clip is watched. A larger quantity of times that the video clip is watched indicates a higher degree of highlighting of the video clip, that is, a higher degree of highlighting. During specific implementation, the server 203 may obtain a quantity of times that each video clip is played, and use the quantity of playing times as a degree of highlighting of the video, or may convert the quantity of playing times into a number in a 10-point system or a 100-point system according to a preset function, and use the number as a degree of highlighting of the video clip. A larger number indicates a higher degree of highlighting of the video clip. For another example, the server 203 may alternatively measure a degree of highlighting of a video clip based on a quantity of comments (such as bullet screens) made by users on the video clip. A larger quantity of comments made by the users indicates a higher degree of highlighting of the video clip. During specific implementation, the server 203 may obtain a quantity of comments (such as bullet screens) made by the users on each video clip, and use the quantity of comments as the degree of highlighting of the video, or may convert the quantity of comments into a number in a 10-point system or a 100-point system according to a preset function, and use the number as the degree of highlighting of the video clip. A larger number indicates a higher degree of highlighting of the video clip. For another example, a relatively highlighting clip in a movie is usually a scene in which an emotion burst of a character occurs or characters fiercely fight. An emotion burst of a character is accompanied by a pitch or frequency increase of sound of the character, and there may be some loud noise in the scene in which the characters fiercely fight. The server 203 may determine the degree of highlighting of each video clip based on a frequency or pitch of sound in each video clip with same playing sound.

In a possible implementation, the server 203 may alternatively determine the degree of highlighting of each video clip based on some features (for example, an image feature such as luminance, a color, and texture of each frame of image in the video clip) of each video clip. In this case, each video clip needs to be analyzed.

When analyzing each video clip, the server 203 may determine the degree of highlighting of each video clip based on a preset neural network model.

First, the server 203 may extract a first feature of each video clip based on the preset neural network model. The first feature includes some or all of the following: a temporal feature of a frame sequence and a spatial feature of the frame sequence.

Each video clip includes an image frame sequence. A spatial feature of each video clip corresponds to the spatial feature of the frame sequence, is appearance features, of the image frames, extracted based on the preset neural network model, and represents abundance of information such as colors, luminance, contrast, definitions, and texture of the image frames.

A temporal feature of each video clip corresponds to the temporal feature of the frame sequence, is appearance features, of a plurality of consecutive image frames, extracted based on the preset neural network model, and represents mutual association of information such as colors, luminance, contrast, definitions, and texture of the plurality of consecutive image frames, and a motion intensity of an object in the plurality of consecutive image frames.

The preset neural network model is a model that is obtained in advance by training sample data and that can output the first feature of the video clip. The sample data is a video clip that has been marked with a degree of highlighting. After the training, the first feature of the video clip can be extracted based on the preset neural network model.

Based on the preset neural network model, only the spatial feature of the video clip may be extracted, or only the temporal feature of the video clip may be extracted, or both the spatial feature and the temporal feature of the video clip may be extracted.

A quantity of network layers included in the preset neural network model and types of the network layers are not limited in this embodiment of this application. Any neural network model based on which a spatial feature of a video clip can be extracted is applicable to this embodiment of this application. The following describes a neural network model and a process of extracting the first feature based on the neural network model.

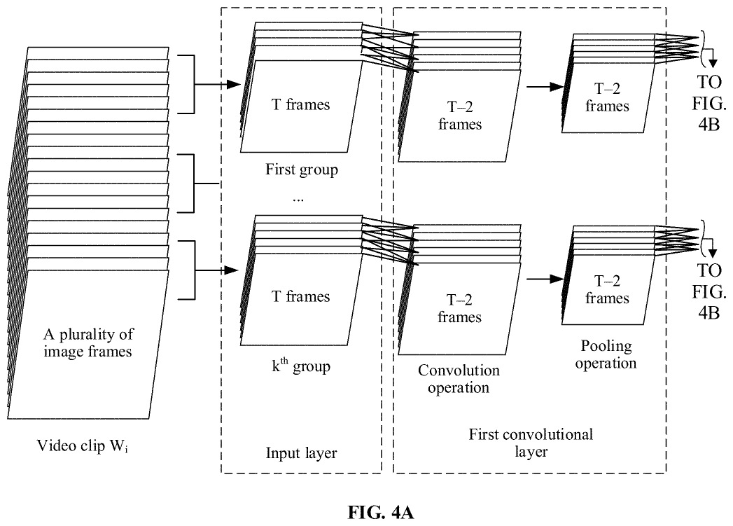

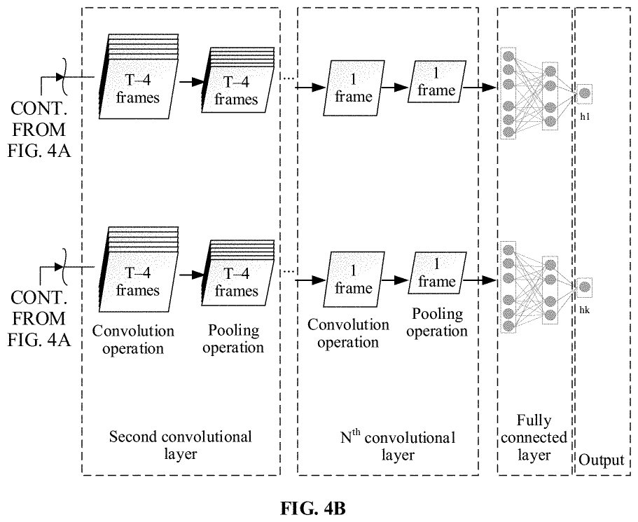

FIG. 4A and FIG. 4B show a structure of a neural network model according to an embodiment of this application. The neural network model includes an input layer, N convolutional layers (to distinguish between the convolutional layers, the convolutional layers are referred to as a first convolutional layer, a second convolutional layer, . . . , and an N^{th} convolutional layer in a direction from the input layer to an output layer), a fully connected layer, and the output layer.

Any video clip including a plurality of image frames is input to the input layer of the neural network model shown in FIG. 4A and FIG. 4B. The input layer classifies the plurality of image frames in the video clip into groups, and each group includes T image frames. The groups of image frames are then input to the N convolutional layers. Each convolutional layer performs a convolution operation (for example, a 3D convolution operation) and a pooling operation (for example, a max-pooling operation) on each group of image frames. Each time a convolution operation is performed, two frames are deducted from each group of image frames until one image frame is obtained after an N^{th} convolution layer performs a convolution operation and a pooling operation. Then, the one obtained image frame is input to the fully connected layer for processing. The fully connected layer inputs processed data to the output layer, and the output layer outputs the first feature (represented by HO FIG. 4A and FIG. 4B) of the video clip.

The server then determines the degree of highlighting of each video clip based on the first feature of each video clip.

Generally, the first feature extracted based on the preset neural network model is a vector or data in a relatively complex form, and cannot intuitively reflect the degree of highlighting of the video clip. The server may convert the extracted first feature of the video clip into a relatively intuitive degree of highlighting of the video clip, for example, convert the first feature of the video clip into the degree of highlighting according to a preset function. A representation manner of the function is not limited in this embodiment of this application, and any function that can convert the first feature of the video clip into the degree of highlighting is applicable to this embodiment of this application.

In a possible implementation, the server may convert the first feature according to a softmax function:

$${H}_{i} = \frac{{e}^{\vert \vert {w}_{i} \vert \vert}}{{\sum }_{i}^{N} {e}^{\vert \vert {w}_{i} \vert \vert}}$$

Hᵢ represents a degree of highlighting of the i^{th} video clip, Hᵢ∈(0, 1), Hᵢ closer to 1 indicates a higher degree of highlighting of the video clip, wᵢ represents a first feature of the i^{th} video clip, and N represents a total quantity of video clips.

The preset neural network model may alternatively have both a function of extracting the first feature of the video clip and a function of converting the first feature of the video clip into the degree of highlighting, so that the preset neural network model can directly output the degree of highlighting of the video clip.

The server measures a degree of highlighting of a video clip and determines the degree of highlighting of the video clip by using many methods. The foregoing manner is merely an example for description. Any manner in which a degree of highlighting of a video clip can be determined is applicable to this embodiment of this application.

After determining the degree of highlighting of each video clip, the server may select N video clips based on the degree of highlighting of each video clip. For example, the server may select the first N video clips sorted in descending order of degrees of highlighting, or may set a preset range of degrees of highlighting, and select N video clips whose degrees of highlighting fall within the preset range.

After selecting the N video clips, the server determines N dotting positions of the video based on positions of the N video clips in the video, where one of the dotting positions corresponds to one of the N video clips.

After determining the dotting position and the video clip corresponding to each dotting position, the server may locally store information about the dotting position and the corresponding video clip, or may store information about the dotting position and the corresponding video clip in another server.

The information about the dotting position is information that can identify the dotting position, and includes some or all of the following information:

an identifier of the dotting position and a position of the dotting position on a progress bar of the video.

When there is more than one dotting position in the video, to distinguish between different dotting positions, identifiers may be set for the dotting positions. For example, the dotting positions may be numbered, or may be distinguished between each other by letters. That is, the identifier of the dotting position may be a number or a letter, or may be a specific time point. Any manner in which different dotting positions can be identified is applicable to this embodiment of this application.

For any video clip, the server may determine a dotting position of the video based on a position of the video clip in the video, and the server may use a start position of the video clip in the video as the dotting position. In this case, a position of the video clip on the progress bar of the video is the dotting position of the video, and there is a correspondence between the dotting position and the video clip.

The video clip that corresponds to the dotting position and that is stored in the server may contain audio, or may not contain audio, for example, may be an animated image.

After the terminal device sends the first request to the server, the server may send, to the terminal device, the first response that carries the dotting information.

The first response further includes the video address, and the video address is a storage address of the video.

In this embodiment of this application, to enable transmitted information to occupy fewer resources, the server uses the first response to carry only the video address and the dotting information of the video. When the terminal device is to display the video or the video clip, the terminal device may obtain the video or the video clip based on the video address or the dotting information of the video.

Optionally, to play the video or the video clip more flexibly, the terminal device may alternatively send a request for the video to the server. The server may feed back a response message that carries the video, the dotting position of the video, and the video clip corresponding to the dotting position of the video. After receiving the response message, the terminal device may flexibly select a time and a manner for displaying the video and the video clip.

After receiving the first response, to obtain the video, the terminal device may send a request for obtaining the video to the server or a device that stores the video. The request may carry the video address.

After obtaining the video, the terminal device may preload the video clip corresponding to each dotting position, or may preload video clips corresponding to some dotting positions. For example, the terminal device may load only a video clip corresponding to a dotting position that is sorted in a former part (a former playing position) of the progress bar. When the terminal device plays the video to a latter position on the progress bar, the terminal device loads a video clip corresponding to a remaining dotting position.

In a possible implementation, the terminal device may alternatively play the video while loading the corresponding video clip in the dotting position. For example, when playing the video, the terminal device may load video clips corresponding to at least one or more dotting positions closest to a current playing position. Alternatively, when playing the video, the terminal device may load a corresponding video clip in each dotting position based on the dotting position on the progress bar.

That the terminal device loads the corresponding video clip in the dotting position based on the storage address of the video clip corresponding to the dotting position may specifically include: The terminal device first sends a second request to the server, where the second request is used to request the video clip corresponding to the dotting position, the second request includes the storage address of the video clip corresponding to the dotting position. Then, the terminal device receives the video clip returned by the server.

In a possible implementation, the second request may include an identifier of the video clip corresponding to the dotting position, so that the server obtains the corresponding video clip based on the identifier and returns the video clip to the terminal device.

Specifically, when the terminal device loads only video clips corresponding to some dotting positions of the video, the second request may be used to request the video clips corresponding to some dotting positions of the video, and the second request includes storage addresses of the video clips corresponding to the dotting positions of the video. When the terminal device needs to load the video clips corresponding to all the dotting positions of the video, the second request is used to request the video clips corresponding to all the dotting positions of the video, and the second request includes storage addresses of the video clips corresponding to all the dotting positions of the video.

After receiving the second request, the server obtains, based on the second request, that is, based on the storage address of the video clip corresponding to the dotting position, the video clip corresponding to the dotting position, uses a second response to carry the video clip corresponding to the dotting position, and sends the second response to the terminal device. After receiving the second response sent by the server, the terminal device may play the corresponding video clip.

When the terminal device plays the video and the video clip, there may be specifically the following two cases:

Case 1: When playing the video, the terminal device actively plays a video clip corresponding to at least one dotting position closest to the current playing position.

The terminal device displays a small window in the least one dotting position closest to the current playing position, and plays a corresponding video clip. Alternatively, split-screen display may be performed in a display interface of the video. To be specific, the display interface of the video is divided into two parts. One part is used to play the current video, and the other part is used to play the video clip corresponding to the at least one dotting position closest to the current playing position.

Case 2: The terminal device plays, after receiving a trigger operation in the dotting position, the video clip corresponding to the dotting position.

The trigger operation in the dotting position may be detecting that a cursor stays in the dotting position, or may be detecting a single tap operation or a double tap operation performed by the user in the dotting position by using a mouse, or may be detecting that the user taps the screen in the dotting position.

After receiving the triggering operation in the dotting position, the terminal device may display a small window in the dotting position, and play a corresponding video clip.

It should be noted that, when playing the video and the video clip, the terminal device may play the video and the video clip at the same time. For example, in the case 1, the terminal device may play the video in a large window, and play the video clip in a small window. In order not to affect user experience, when playing the video clip, the terminal device may play only an image of the video clip, but do not play sound. Alternatively, the terminal device may pause playing the video, and play only the video clip. For example, in the case 2, after receiving the trigger operation in the dotting position, the terminal device may pause playing the video, and display a small window in the dotting position, to play the video clip (play both an image and sound) corresponding to the dotting position.

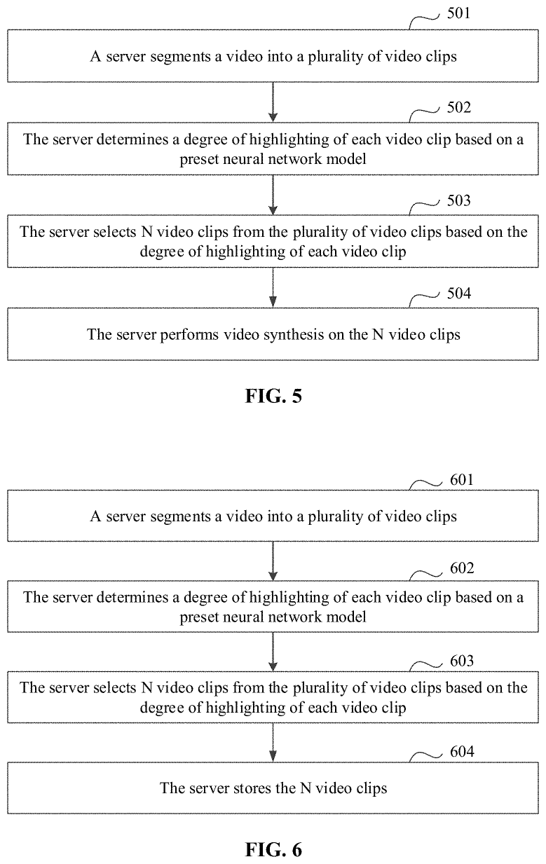

FIG. 5 is a diagram of a video clip generation method according to an embodiment. As shown in FIG. 5, an embodiment of this application further provides a video clip generation method. The method includes the following steps.

Step 501: A server segments a video into a plurality of video clips.

Step 502: The server determines a degree of highlighting of each video clip based on a preset neural network model.

For a manner in which the server segments the video and determines the degree of highlighting of each video clip, refer to related descriptions in the embodiment shown in FIG. 4A and FIG. 4B. Details are not described herein again.

Step 503: The server selects N video clips from the plurality of video clips based on the degree of highlighting of each video clip.

The server selects the N video clips in many manners. For example, the server may select the first N video clips sorted in descending order of degrees of highlighting, or may set a preset range of degrees of highlighting, and select N video clips whose degrees of highlighting fall within the preset range.

Step 504: The server performs video synthesis on the N video clips.

After selecting the N video clips, the server may synthesize the N video clips into one video (for ease of description, a first video is used to represent the video obtained after the video synthesis). After performing video synthesis, the server may store the video obtained after the video synthesis, for example, may locally store the first video, or may store the first video in another server.

Then, the terminal device may send a request for an address of the first video to the server, and the server may send the address of the first video to the terminal device.

When the terminal device determines that the first video is required, for example, after the terminal device determines to display the first video, the terminal device sends, to the server, a request that carries the address of the first video. After receiving the request, the server sends the first video to the terminal device.

In a possible implementation, after performing video synthesis on the N video clips, the server may directly send the first video to the terminal device. Interaction between the server and the terminal device for obtaining the address of the first video may alternatively be omitted. Instead, the terminal device directly sends a request for the first video to the server, and the server directly sends the first video to the terminal device.

FIG. 6 is a diagram of another video clip generation method according to an embodiment. As shown in FIG. 6, an embodiment of this application further provides a video clip generation method. The method includes the following steps.

Step 601: A server segments a video into a plurality of video clips.

Step 602: The server determines a degree of highlighting of each video clip based on a preset neural network model.

Step 603: The server selects N video clips from the plurality of video clips based on the degree of highlighting of each video clip.

For a manner in which the server segments the video and determines the degree of highlighting of each video clip, and a step of selecting a video clip, refer to related descriptions in the embodiment shown in FIG. 5. Details are not described herein again.

Step 604: The server stores the N video clips.

The N video clips stored in the server may contain audio, or may not contain audio, for example, may be animated images.

After storing the N video clips, the server may send the N video clips to the terminal device. The server may directly send the N video clips, or may send the N video clips after receiving a request from the terminal device. The following provides a description by using an example in which the N video clips stored in the server are N animated images.

The terminal device may send a request for addresses of the animated images to the server, and the server may send the addresses of the animated images to the terminal device.

When the terminal device determines that the animated images are required, for example, after the terminal device determines to display the animated images, the terminal device sends, to the server, a request that carries the addresses of the animated images. After receiving the request, the server sends the animated images to the terminal device.

In a possible implementation, the server may directly send the animated images to the terminal device. Interaction between the server and the terminal device for obtaining the addresses of the animated images may alternatively be omitted. The terminal device directly sends a request for the animated images to the server, and the server directly sends the animated images to the terminal device.

It should be noted that, during interaction between the terminal device and the server, only some of the N animated images may be obtained, or all of the N animated images may be obtained. This is not limited in this embodiment of this application.

FIG. 7 is a structural diagram of a server according to an embodiment. Based on a same inventive concept as the method embodiments, an embodiment of the present invention provides a server. The server is specifically configured to implement the method performed by the server in the method embodiment shown in FIG. 3. A structure of the server is in shown in FIG. 7, and includes a receiving unit 701 and a sending unit 702.

The receiving unit 701 is configured to receive a first request from a terminal device, where the first request is used to request an address of a video to be played by the terminal device.

The sending unit 702 is configured to send a first response to the terminal device, where the first response includes the video address and dotting information of the video, and the dotting information includes a dotting position of the video and a storage address of a video clip corresponding to the dotting position.

In a possible implementation, the server may further send the video clip to the terminal device.

Specifically, the server 700 further includes a processing unit 703. The receiving unit 701 receives a second request sent by the terminal device, where the second request is used to request the video clip corresponding to the dotting position, and the second request includes the storage address of the video clip corresponding to the dotting position. After the receiving unit 701 receives the second request, the processing unit 703 obtains, based on the storage address of the video clip corresponding to the dotting position, the video clip corresponding to the dotting position, and then the sending unit 702 may send a second response to the terminal device. The second response includes the video clip corresponding to the dotting position.

To send the dotting information to the terminal device, before the sending unit 702 sends the first response to the terminal device, the processing unit 703 may be configured to determine the dotting position and the video clip corresponding to the dotting position. Specifically, the processing unit 703 first segments the video into a plurality of video clips, determines a degree of highlighting of each video clip based on a preset neural network model, and selects N video clips based on the degree of highlighting of each video clip. After selecting the N video clips, the processing unit 703 may determine N dotting positions of the video based on positions of the N video clips in the video, where one of the dotting position corresponds to one of the N video clips.

In a possible implementation, in a process in which the processing unit 703 determines the degree of highlighting of each video clip based on the preset neural network model, the processing unit 703 may extract a first feature of each video clip based on the preset neural network model. The first feature includes some or all of the following: a temporal feature of a frame sequence and a spatial feature of the frame sequence. Then, the processing unit 703 determines the degree of highlighting of each video clip based on the first feature of each video clip.

The processing unit 703 segments the video into the plurality of video clips in many manners, and two of the manners are listed below:

Manner 1: Lengths of video clips obtained through segmentation are the same, and are a preset length.

The processing unit 703 first performs shot segmentation on the video based on shot types of the video, to obtain a plurality of groups of image frames, where each group of image frames includes a plurality of consecutive image frames; and then synthesizes the plurality of groups of image frames into one or more video clips with the preset length.

Manner 2: A video clip obtained through segmentation displays a specific scene or a specific character.

The processing unit 703 first performs shot segmentation on the video to obtain a plurality of groups of image frames, where each group of image frames includes a plurality of consecutive image frames; and then synthesizes the plurality of groups of image frames into one or more video clips, where a similarity between any two adjacent frames of images in one video clip falls within a preset range.

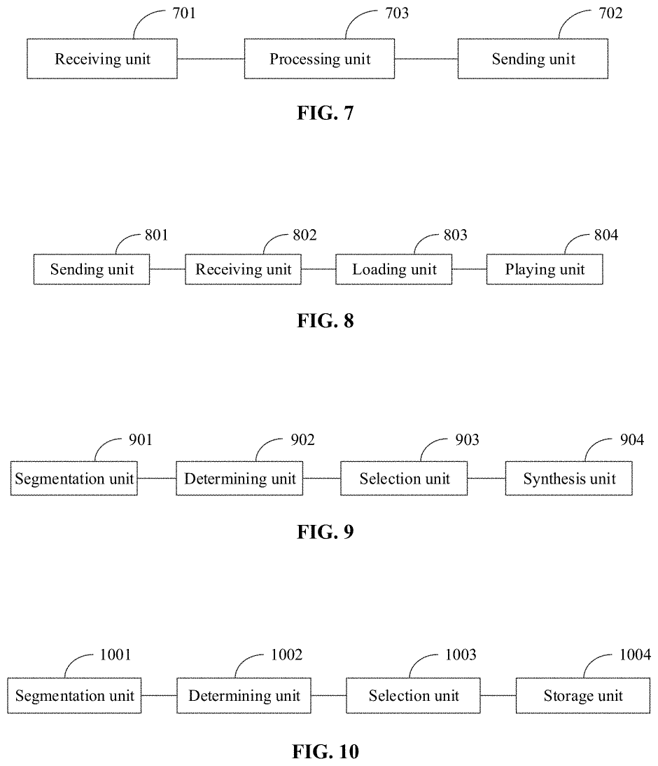

FIG. 8 is a structural diagram of a terminal device according to an embodiment. Based on a same inventive concept as the method embodiments, an embodiment of the present invention provides a terminal device. The terminal device is specifically configured to implement the method performed by the terminal device in the method embodiment shown in FIG. 3. A structure of the terminal device is shown in FIG. 8, and includes a sending unit 801, a receiving unit 802, a loading unit 803, and a playing unit 804.

The sending unit 801 is configured to send a first request to a server, where the first request is used to request an address of a video to be played by the terminal device.

The receiving unit 802 is configured to receive a first response sent by the server, where the first response includes the video address and dotting information of the video, and the dotting information includes a dotting position of the video and a storage address of a video clip corresponding to the dotting position.

The loading unit 803 is configured to: obtain the video based on the video address, and load the corresponding video clip in the dotting position based on the storage address of the video clip corresponding to the dotting position.

The playing unit 804 is configured to play the video and the video clip.

When the loading unit 803 loads the corresponding video clip in the dotting position based on the storage address of the video clip corresponding to the dotting position, the terminal device may interact with the server. Specifically, the sending unit 801 first sends a second request to the server, where the second request is used to request the video clip corresponding to the dotting position, and the second request includes the storage address of the video clip corresponding to the dotting position. Then, the receiving unit 802 receives a second response sent by the server, where the second response includes the video clip corresponding to the dotting position. After the second response is received, the loading unit 803 loads the corresponding video clip in the dotting position based on the second response.

In a possible implementation, when playing the video clip, the playing unit 804 may display a video clip corresponding to at least one dotting position closest to a current playing position.

In another possible implementation, when playing the video clip, the playing unit 804 may play, after a trigger operation in the dotting position is received, the video clip corresponding to the dotting position.

FIG. 9 is a structural diagram of a server according to an embodiment. Based on a same inventive concept as the method embodiments, an embodiment of the present invention provides a server. The server is specifically configured to implement the method performed by the server in the method embodiment shown in FIG. 5. A structure of the server is shown in FIG. 9, and includes a segmentation unit 901, a determining unit 902, a selection unit 903, and a synthesis unit 904.

The segmentation unit 901 is configured to segment a video into a plurality of video clips.

The determining unit 902 is configured to determine a degree of highlighting of each video clip based on a preset neural network model.

The selection unit 903 is configured to select N video clips from the plurality of video clips based on the degree of highlighting of each video clip.

The synthesis unit 904 is configured to perform video synthesis on the N video clips.

Optionally, the server may further include a storage unit, and the storage unit is configured to store a video obtained after the video synthesis.

FIG. 10 is a structural diagram of a server according to an embodiment. Based on a same inventive concept as the method embodiments, an embodiment of the present invention provides a server. The server is specifically configured to implement the method performed by the server in the method embodiment shown in FIG. 6. A structure of the server is shown in FIG. 10, and includes a segmentation unit 1001, a determining unit 1002, a selection unit 1003, and a storage unit 1004.

The segmentation unit 1001 is configured to segment a video into a plurality of video clips.

The determining unit 1002 is configured to determine a degree of highlighting of each video clip based on a preset neural network model.

The selection unit 1003 is configured to select N video clips from the plurality of video clips based on the degree of highlighting of each video clip.

The storage unit 1004 is configured to store the N video clips.

Division into the units in this embodiment of this application is an example and is merely logical function division. In actual implementation, another division manner may be used. In addition, function units in this embodiment of this application may be integrated in one processor, or may exist alone physically, or two or more units may be integrated into one module. The integrated unit may be implemented in the form of hardware, or may be implemented in the form of a software function module.

When the integrated unit is implemented in the form of a software functional unit and sold or used as an independent product, the integrated unit may be stored in a computer readable storage medium. Based on such an understanding, the technical solutions of this application essentially, or the part contributing to the prior art, or all or some of the technical solutions may be implemented in the form of a software product. The software product is stored in a storage medium and includes several instructions for instructing a terminal device (which may be a personal computer, a mobile phone, a network device, or the like) or a processor (processor) to perform all or some of the steps of the methods in the embodiments of this application. The foregoing storage medium includes any medium that can store program code, for example, a USB flash drive, a removable hard disk, a read-only memory (read-only memory, ROM), a random access memory (random access memory, RAM), a magnetic disk, or an optical disc.

In the embodiments of this application, both the server and the terminal device may be divided into function modules through integration. The “module” herein may be a specific ASIC, a circuit, a processor executing one or more software or firmware programs, a memory, an integrated logic circuit, and/or another device that can provide the foregoing functions.

In a simple embodiment, a person skilled in the art may figure out that the terminal device may be in a form shown in FIG. 8.

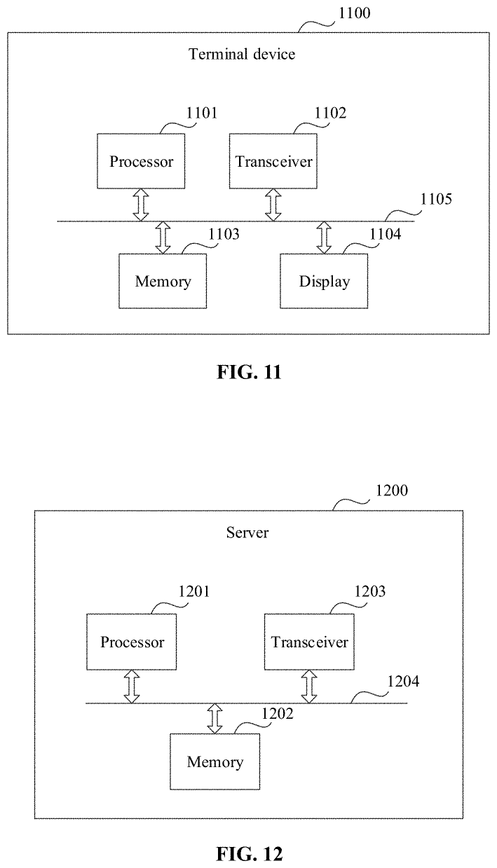

FIG. 11 is a structural diagram of a terminal device according to an embodiment. The terminal device 1100 shown in FIG. 11 includes at least one processor 1101, and optionally, may further include a transceiver 1102 and a memory 1103.

In a possible implementation, the terminal device 1100 may further include a display 1104.

The memory 1103 may be a volatile memory such as a random access memory. Alternatively, the memory may be a non-volatile memory such as a read-only memory, a flash memory, a hard disk drive (hard disk drive, HDD), or a solid-state drive (solid-state drive, SSD). Alternatively, the memory 1103 is any other medium that can be used to carry or store expected program code in a command or data structure form and that can be accessed by a computer. However, this is not limited. The memory 1103 may be a combination of the foregoing memories.

In this embodiment of this application, a specific connection medium between the processor 1101 and the memory 1103 is not limited. In this embodiment of this application, the memory 1103 and the processor 1101 are connected through a bus 1105 in the figure. The bus 1105 is indicated by using a bold line in the figure. A manner of connection between other components is merely an example for description, and is not limited thereto. The bus 1105 may be classified into an address bus, a data bus, a control bus, or the like. For ease of representation, only one bold line is used to represent the bus in FIG. 11, but this does not mean that there is only one bus or only one type of bus.

The processor 1101 may have data receiving and sending functions, and can communicate with another device. For example, in this embodiment of this application, the processor 1101 may send a first request or a second request to a server, or may receive a first response or a second response from the server. In the apparatus shown in FIG. 11, an independent data transceiver module may be disposed. For example, the transceiver 1102 is configured to receive and send data. When communicating with another device, the processor 1101 may transmit data through the transceiver 1102. For example, in this embodiment of this application, the processor 1101 may send the first request or the second request to the server through the transceiver 1102, or may receive the first response or the second response from the server through the transceiver 1102.

When the terminal device is in a form shown in FIG. 11, the processor 1101 in FIG. 11 may invoke a computer executable instruction stored in the memory 1103, so that the terminal device can perform the method performed by the terminal device in any one of the foregoing method embodiments.

Specifically, the memory 1103 stores a computer executable instruction used to implement functions of the sending unit, the receiving unit, the loading unit, and the playing unit in FIG. 8. All functions/implementation processes of the sending unit, the receiving unit, the loading unit, and the playing unit in FIG. 8 may be implemented by the processor 1101 in FIG. 11 by invoking the computer executable instruction stored in the memory 1103.

Alternatively, the memory 1103 stores a computer executable instruction used to implement functions of the loading unit and the playing unit in FIG. 8. Functions/implementation processes of the loading unit and the playing unit in FIG. 8 may be implemented by the processor 1101 in FIG. 11 by invoking the computer executable instruction stored in the memory 1103. Functions/implementation processes of the sending unit and the receiving unit in FIG. 8 may be implemented by the transceiver 1102 in FIG. 11.

In addition to the computer executable instruction, the memory 1103 may be further configured to store video data or dotting information required by the sending unit, the receiving unit, the loading unit, and the playing unit in FIG. 8. For example, the memory 1103 may store the video address, the video clip, the video, or the dotting information of the video.

When the processor 1101 performs a function of the playing unit, if the processor 1101 performs an operation of playing a video or a video clip, the processor 1101 may display the played video or video clip by using the display 1104 in the terminal device.

Optionally, when performing a function of the display unit, the processor 1101 may alternatively display a video or a video clip by using a display in another device, for example, send a play instruction to the another device to indicate a video or a video clip.

FIG. 12 is a structural diagram of a server according to an embodiment. In a simple embodiment, a person skilled in the art may figure out that the server may be in a form shown in FIG. 12.

A server 1200 shown in FIG. 12 includes at least one processor 1201, and optionally, may further include a memory 1202 and a transceiver 1203.

The memory 1202 may be a volatile memory such as a random access memory. Alternatively, the memory may be a non-volatile memory such as a read-only memory, a flash memory, a hard disk drive, or a solid-state drive. Alternatively, the memory 1202 is any other medium that can be used to carry or store expected program code in a command or data structure form and that can be accessed by a computer. However, this is not limited. The memory 1202 may be a combination of the foregoing memories.

In this embodiment of this application, a specific connection medium between the processor 1201 and the memory 1202 is not limited. In this embodiment of this application, the memory 1202 and the processor 1201 are connected through a bus 1204 in the figure. The bus 1204 is indicated by using a bold line in the figure. A manner of connection between other components is merely an example for description, and is not limited thereto. The bus 1204 may be classified into an address bus, a data bus, a control bus, or the like. For ease of representation, only one bold line is used to represent the bus in FIG. 12, but this does not mean that there is only one bus or only one type of bus.

The processor 1201 may have data receiving and sending functions, and can communicate with another device. In the apparatus shown in FIG. 12, an independent data transceiver module may alternatively be disposed. For example, the transceiver 1203 is configured to receive and send data. When the processor 1201 communicates with another device, data may be transmitted through the Transceiver 1203.

When the server is in a form shown in FIG. 12, the processor 1201 in FIG. 12 may invoke a computer executable instruction stored in the memory 1202, so that the server can perform the method performed by the server in any one of the foregoing method embodiments.

Specifically, the memory 1202 stores a computer executable instruction used to implement functions of the sending unit, the receiving unit, and the processing unit in FIG. 7. All functions/implementation processes of the sending unit, the receiving unit, and the processing unit 703 in FIG. 7 may be implemented by the processor 1201 in FIG. 12 by invoking the computer executable instruction stored in the memory 1202. Alternatively, the memory 1202 stores a computer executable instruction used to implement a function of the processing unit 703 in FIG. 7. A function/implementation process of the processing unit 703 in FIG. 7 may be implemented by the processor 1201 in FIG. 12 by invoking the computer executable instruction stored in the memory 1202. Functions/implementation processes of the sending unit and the receiving unit in FIG. 7 may be implemented by the transceiver 1203 in FIG. 12.

In addition to the computer executable instruction, the memory 1202 may be further configured to store video data or dotting information required by the sending unit, the receiving unit, and the processing unit in FIG. 7. For example, the memory 1202 may store the video address, the video clip, the video, or the dotting information of the video.

Specifically, the memory 1202 stores a computer executable instruction used to implement functions of the segmentation unit, the determining unit, the selection unit, and the synthesis unit in FIG. 9, and functions/implementation processes of the segmentation unit, the determining unit, the selection unit, and the synthesis unit in FIG. 9 may be implemented by the processor 1201 in FIG. 12 by invoking the computer executable instruction stored in the memory 1202. Optionally, the processor 1201 may further send the first video to another device through the transceiver 1203.

In addition to the computer executable instruction, the memory 1202 may be further configured to store video data required by the segmentation unit, the determining unit, the selection unit, and the synthesis unit in FIG. 9. For example, the memory 1202 may store the video clip, the video, and the first video.

Specifically, the memory 1202 stores a computer executable instruction used to implement functions of the segmentation unit, the determining unit, the selection unit, and the storage unit in FIG. 10, and functions/implementation processes of the segmentation unit, the determining unit, the selection unit, and the storage unit in FIG. 10 may be implemented by the processor 1201 in FIG. 12 by invoking the computer executable instruction stored in the memory 1202. Optionally, the processor 1201 may further send the stored video clip to another device through the transceiver 1203.

In addition to the computer executable instruction, the memory 1202 may be further configured to store video data required by the segmentation unit, the determining unit, the selection unit, and the storage unit in FIG. 10. For example, the memory 1202 may store the video clip, the video, and the animated image.

A person skilled in the art should understand that the embodiments of this application may be provided as a method, a system, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a magnetic disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by the computer or the processor of the any other programmable data processing device generate an apparatus for implementing a specific function in one or more processes in the flowcharts and/or in one or more blocks in the block diagrams.

These computer program instructions may alternatively be stored in a computer readable memory that can instruct the computer or the another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto the computer or the another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

It is clear that a person skilled in the art can make various modifications and variations to this application without departing from the spirit and scope of this application. This application is intended to cover these modifications and variations of this application provided that they fall within the scope defined by the following claims and their equivalent technologies.

What is claimed is:

1. A video playing method, the method comprising:
receiving, by a server, a first request from a terminal device, the first request requesting a video address of a video to be played by the terminal device; and
sending, by the server, a first response to the terminal device, the first response comprising the video address and dotting information of the video, the dotting information comprising a dotting position of the video and a storage address of a video clip corresponding to the dotting position.

2. The method according to claim 1, wherein after the sending, by the server, the first response to the terminal device, the method further comprises:
receiving, by the server, a second request sent by the terminal device, the second request requesting the video clip corresponding to the dotting position, the second request comprising the storage address of the video clip;
obtaining, by the server based on the storage address of the video clip, the video clip; and
sending, by the server, a second response to the terminal device, the second response comprising the video clip corresponding to the dotting position.

3. The method according to claim 1, wherein before the sending, by the server, the first response to the terminal device, the method further comprises:
segmenting, by the server, the video into a plurality of video clips;
determining, by the server, a degree of highlighting of each video clip of the plurality of video clips based on a preset neural network model;
selecting, by the server, N video clips of the plurality of video clips based on the degree of highlighting of each video clip of the plurality of video clips; and
determining, by the server, N dotting positions of the video based on positions of the N video clips in the video, wherein each dotting position of the N dotting positions corresponds to a video clip of the N video clips.

4. The method according to claim 3, wherein the determining, by the server, the degree of highlighting of the each video clip based on a preset neural network model comprises:
extracting, by the server, a first feature of the each video clip based on the preset neural network model, the first feature comprising one or both of a temporal feature of a frame sequence or a spatial feature of the frame sequence; and
determining, by the server, the degree of highlighting of the each video clip based on the first feature of the each video clip.

5. The method according to claim 3, wherein the segmenting, by the server, the video into the plurality of video clips comprises:
performing, by the server, shot segmentation on the video to obtain a plurality of groups of image frames, wherein each group of image frames of the plurality of groups of image frames comprises a plurality of consecutive image frames; and
synthesizing, by the server, the plurality of groups of image frames into one or more video clips with a preset length.

6. The method according to claim 3, wherein the segmenting, by the server, the video into the plurality of video clips comprises:
performing, by the server, shot segmentation on the video based on shot types of the video to obtain a plurality of groups of image frames, wherein each group of image frames comprises a plurality of consecutive image frames; and
synthesizing, by the server, the plurality of groups of image frames into one or more video clips, wherein a similarity between two adjacent frames in a video clip falls within a preset range.

7. A video playing method, the method comprising:
receiving, by a terminal device, a first response sent by a server after sending a first request to the server, the first request requesting a video address of a video to be played by the terminal device, the first response comprising the video address and dotting information of the video, the dotting information comprising a dotting position of the video and a storage address of a video clip corresponding to the dotting position;
obtaining, by the terminal device, the video based on the video address;
loading the corresponding video clip based on the storage address of the video clip; and
playing, by the terminal device, the video clip.

8. The method according to claim 7, wherein the loading, by the terminal device, the corresponding video clip comprises:
sending, by the terminal device, a second request to the server, the second request requesting the video clip, the second request comprising the storage address of the video clip; and
receiving, by the terminal device, a second response sent by the server, the second response comprising the video clip corresponding to the dotting position.

9. The method according to claim 7, the method further comprising:
displaying, by the terminal device, a video clip corresponding to at least one dotting position closest to a current playing position when playing the video.

10. The method according to claim 7, the method further comprising:
playing, by the terminal device after receiving a trigger operation in the dotting position, the video clip corresponding to the dotting position when playing the video.

11. A server, comprising:
a processor; and
a memory coupled to the processor and configured to store instructions that, when executed by the processor, cause the server to be configured to:
receive a first request from a terminal device, the first request requesting a video address of a video to be played by the terminal device; and
send a first response to the terminal device, the first response comprising the video address and dotting information of the video, the dotting information comprising a dotting position of the video and a storage address of a video clip corresponding to the dotting position.

12. The server according to claim 11, wherein the server is further configured to:
receive a second request sent by the terminal device, the second request requesting the video clip corresponding to the dotting position, the second request comprising the storage address of the video clip corresponding to the dotting position;
obtain, based on the storage address of the video clip, the video clip; and
send a second response to the terminal device, the second response comprising the video clip corresponding to the dotting position.

13. The server according to claim 11, wherein before the first response is sent to the terminal, the server is further configured to:
segment the video into a plurality of video clips;
determine a degree of highlighting of each video clip of the plurality of video clips based on a preset neural network model;
select N video clips of the plurality of video clips based on the degree of highlighting of the each video clip of the plurality of video clips; and
determine N dotting positions of the video based on positions of the N video clips in the video, wherein each dotting position corresponds to a video clip of the N video clips.

14. The server according to claim 13, wherein the server is further configured to:
extract a first feature of the each video clip based on the preset neural network model, the first feature comprising one or both of a temporal feature of a frame sequence or a spatial feature of the frame sequence; and
determine the degree of highlighting of the each video clip based on the first feature of the each video clip.

15. The server according to claim 13, wherein the server is further configured to:
perform shot segmentation on the video based on shot types of the video to obtain a plurality of groups of image frames, wherein each group of image frames of the plurality of groups of image frames comprises a plurality of consecutive image frames; and
synthesize the plurality of groups of image frames into one or more video clips with a preset length.

16. The server according to claim 13, wherein when segmenting the video into the plurality of video clips, the server is further configured to:
perform shot segmentation on the video based on shot types of the video to obtain a plurality of groups of image frames, wherein each group of image frames of the plurality of groups of image frames comprises a plurality of consecutive image frames; and
synthesize the plurality of groups of image frames into one or more video clips, wherein a similarity between two adjacent frames in a video clip falls within a preset range.

17. A terminal device, comprising:
a processor; and
a memory coupled to the processor and configured to store instructions that, when executed by the processor, cause the terminal device to be configured to:
send a first request to a server, the first request requesting a video address of a video to be played by the terminal device;
receive a first response sent by the server, the first response comprising the video address and dotting information of the video, the dotting information comprising a dotting position of the video and a video clip storage address of a video clip corresponding to the dotting position;
obtain the video based on the video address;
load the corresponding video clip based on the video clip storage address of the video clip corresponding to the dotting position; and
play the video clip.

18. The terminal device according to claim 17, wherein the terminal device is further configured to:
send a second request to the server, the second request requesting the video clip corresponding to the dotting position, the second request comprising the video clip storage address of the video clip;
receive a second response sent by the server, the second response comprising the video clip corresponding to the dotting position; and
load the video clip based on the second response.

19. The terminal device according to claim 17, the server is further configured to:
display a video clip corresponding to at least one dotting position closest to a current playing position when playing the video.

20. The terminal device according to claim 17, the server is further configured to:
play, after a trigger operation in the dotting position is received, the video clip corresponding to the dotting position when playing the video.
